(19) United States
(12) Patent Application Publication
(10) Pub. No.: US 2025/0267395 A1
(43) Pub. Date: Aug. 21, 2025

(54) INTERFERENCE TUBE FOR A MICROPHONE

(71) Applicant: Shure Acquisition Holdings, Inc., Niles, IL (US)

(72) Inventors: William Wallace Taylor, III, Gurnee, IL (US); Brent Robert Shumard, Mount Prospect, IL (US); Joseph Michael Bradel, South Beloit, IL (US)

(21) Appl. No.: 19/051,466

(22) Filed: Feb. 12, 2025

Related U.S. Application Data
(60) Provisional application No. 63/554,029, filed on Feb. 15, 2024.

(51) Int. Cl. H04R 1/28; H04R 1/08

(52) U.S. Cl. CPC H04R 1/2869; H04R 1/083

(57) ABSTRACT

Apparatuses and methods for a linearly compressed interference tube for use with microphones having an internal acoustic path with a geometry that approximates a longer interference tube within the same linear footprint in order to provide improved low-frequency attenuation and stable polar patterns in the microphones.

### CROSS-REFERENCE TO RELATED APPLICATIONS

This application claims the benefit of U.S. Provisional Patent Application No. 63/554,029, filed on Feb. 15, 2024, which is fully incorporated by reference herein.

### FIELD

The present disclosure relates generally to an interference tube for use with shotgun-style microphones.

### BACKGROUND

Interference-type line microphones, otherwise known as “shotgun” microphones, are a highly directional type of microphone that can “reject” or dampen sounds coming from directions other than directly in front of the microphone capsule (i.e., sounds that are “off-axis”). Shotgun microphones sometimes include a straight, open-ended interference tube appended to the front of the microphone capsule. Off-axis sounds may enter the tube at various lengths from the capsule and may consequently arrive at the capsule out of phase with one another and experience phase interference or phase cancellation (also known as deconstructive interference). The lowest frequency that an interference tube can effectively cancel is a function of the length of the interference tube. Additionally, certain applications often dictate the permissible linear footprint, or length, of an interference tube.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

Aspects of the disclosure pertain to an interference tube comprising an internal acoustic path having a greater length than an external dimension of the interference tube, and a plurality of sound entrance holes. The internal acoustic path may be configured to attenuate at least a first acoustic wave and a second acoustic wave that enter the internal acoustic path through one or more of the plurality of sound entrance holes. Based on the non-linear geometry of the internal acoustic path, the interference tube may attenuate acoustic waves having a lower frequency than that would be attenuated should the internal acoustic path be equal in length to the external dimension of the interference tube.

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1a illustrates an example interference tube.

FIG. 1b illustrates another example interference tube.

FIG. 2 further illustrates the example interference tube of FIG. 1b.

FIG. 3 illustrates another example interference tube.

FIG. 4 illustrates an example flow chart of a method that may be performed to implement one or more illustrative aspects described herein.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

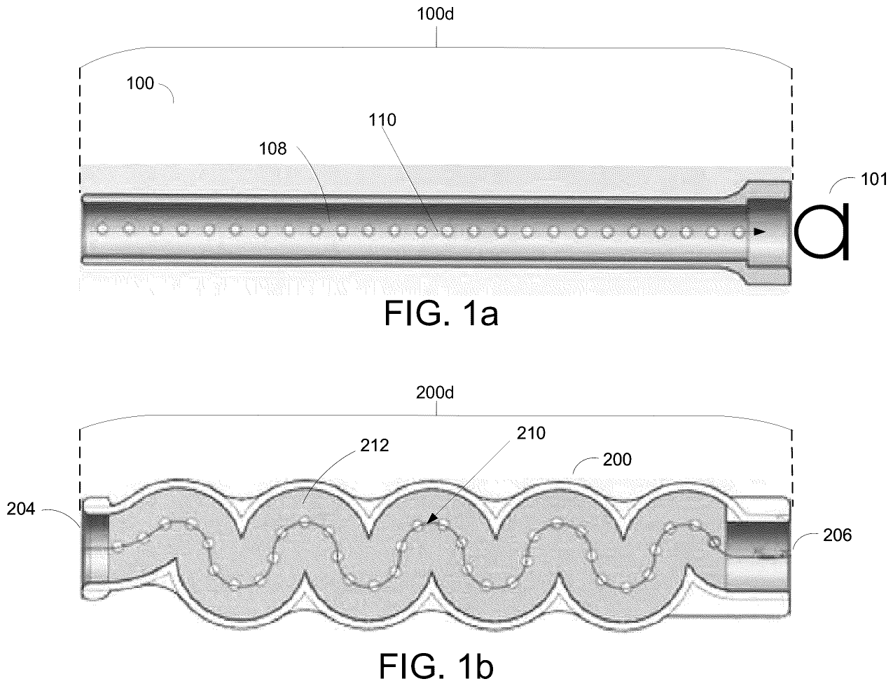

As shown in FIG. 1a, linear interference tube 100 (hereinafter referred to as “tube 100”) may have a linear length, or linear footprint, of 100d. Linear interference tube 100 may include a hollow channel 108 that defines an internal acoustic path defined by arrow 110. Internal acoustic path 110 may have the same length as the overall linear length 100d of tube 100.

Tube 100 may be open-ended and may be appended to the front of microphone capsule 101. Tube 100 may allow sound directly in front of microphone capsule 101 (i.e., “on-axis” sound) to enter tube 100. Tube 100 may be configured to “reject” or dampen sounds coming from directions other than directly in front of the microphone capsule (i.e., sounds that are “off-axis”). Off-axis sounds may enter the tube at various lengths from the capsule and may consequently arrive at the capsule out of phase with one another and experience phase interference or phase cancellation (also known as deconstructive interference).

As discussed above, tube 100 may be configured to cancel, or attenuate, sounds off-axis to capsule 101. For example, tube 100 may include a plurality of sound entrance holes 112 (hereinafter referred to as “holes 112”) disposed along tube 100. Holes 112 may provide channels through which sound waves propagate into channel 108. That is, holes 112 may permit off-axis sound waves to enter channel 108 at various lengths relative to microphone capsule 101. Sound waves that enter channel 108 at different lengths relative to microphone capsule 101 may arrive at microphone capsule 101 out of phase with one another. Consequently, due to destructive interference, those unwanted off-axis sounds may be attenuated by the time they reach microphone capsule 101. However, the lowest frequency that tube 100 can effectively attenuate is a function of length 100d of tube 100. That is, the lower the frequency a user wishes to attenuate, or cancel, the longer dimension 100d must be. Additionally, certain applications often dictate the permissible maximum linear footprint, or length, of an interference tube. Therefore, it might not be practical in some applications to use an interference tube with a given dimension 100d.

FIG. 1b illustrates an example interference tube 200 (hereinafter referred to as “tube 200”) that may be used to implement one or more illustrative aspects described herein. As shown in FIG. 1b, tube 200 may include an internal acoustic path 210 (illustrated by the line) defined by channel 212. Tube 200 may have an overall linear length, or linear footprint, represented by 200d. Dimension 200d may be the same or substantially the same length as 100d. Alternatively, dimension 200d may be shorter or longer than 100d.

Internal acoustic path 210 may be longer in overall length than internal acoustic path 110 due to the non-linearity of internal acoustic path 210. A line connecting the midpoints of front opening 204 and rear opening 206 may define an axis about which internal acoustic path 210 may be formed. Internal acoustic path 210 may be formed by routing tube 200 off-axis in one or multiple dimensions, that is, arranging internal acoustic path 210 non-linearly with respect to said axis defined by the line having endpoints at front opening 204 and rear opening 206. Internal acoustic path 210 may be constructed with any number of non-linear geometries, or shapes, such a sinusoidal waveform (as is shown in FIG. 1b), a helical geometry, and the like. Internal acoustic path 210 may be unidimensional (or monoplanar) with respect to the axis defined by the line connecting front opening 204 and rear opening 206. Internal acoustic path 210 may occupy one or more planes with respect to the axis defined by the line connecting front opening 204 and rear opening 206 (i.e., the non-linearity of internal acoustic path 210 may occur in one or more planes with respect to the axis defined by the line connecting front opening 204 and rear opening 206).

For purposes of illustrating the relationship between the lowest frequency that an interference tube can effectively cancel and the length of the interference tube, consider the following formulas. The wavelength of a sound wave is given by Formula (1) below, where v is the speed of sound in air and f is the frequency of the sound wave.

$$λ = \frac{v}{f} . \qquad Formula ( 1 )$$

The path difference required for maximum destructive interference of two sound waves with a known frequency is given by Formula (2) below, where x is the path difference to cause destructive interference.

$$x = \frac{λ}{2} . \qquad Formula ( 2 )$$

Using a target frequency of 1000 Hz as an example, and assuming that v=343 meters per second (m/s) at 21° C., it follows from Formulas (1) and (2) that the minimum path difference required for destructive interference is 0.1715 meters, or approximately 6.75 inches. Assuming also for purposes of illustration only that dimension 100d=5.2 inches, interference tube 100 may only be effective in reducing off-axis sound down to about 1,300 Hz. Therefore, because half the wavelength of a 1000 Hz sound wave is greater than exterior dimension 100d, interference tube 100 may not effectively reduce off-axis sound waves having at least a frequency of 1000 Hz. Regarding tube 200, sound waves must travel along an internal acoustic path 210, which may have a distance longer than exterior dimension 200d. Accordingly, tube 200 may approximate a “longer” interference tube while having the same or similar exterior dimension 200d as dimension 100d of tube 100, which translates to a lower frequency at which tube 200 may effectively attenuate (or cancel, reduce, reject, etc.) off-axis sound waves. For illustration only, assume the length of the internal acoustic path 210 is about 0.191 m, or 7.5 inches. Accordingly, because the length of the internal acoustic path 210 is greater than half the wavelength of a 1000 Hz sound wave, tube 200 may effectively reduce off-axis sound waves having at least a frequency of about 1000 Hz by providing a distance, or internal acoustic path 210, sufficient for the sound waves to deconstructively interfere with one another in channel 212. The above values for target frequency, exterior dimension 100d, exterior dimension 200d, and internal acoustic path 210 are merely examples. As such, any value for target frequency, exterior dimension 100d, exterior dimension 200d, and internal acoustic path 210 may be used in examples, such as 100 Hz, 200 Hz, 300 Hz, 400 Hz, 1100 Hz, 1200 Hz, etc., for target frequency; 3 inches, 4 inches, 4.5 inches, 5 inches, 5.5 inches, 6 inches, etc. for exterior dimension 100d; 3 inches, 4 inches, 4.5 inches, 5 inches, 5.5 inches, 6 inches, 7 inches etc. exterior dimension 200d; and 4 inches, 4.5 inches, 5 inches, 5.5 inches, 6 inches, 6.5 inches, 7 inches, 8 inches, 8.5 inches, etc. for internal acoustic path 210.

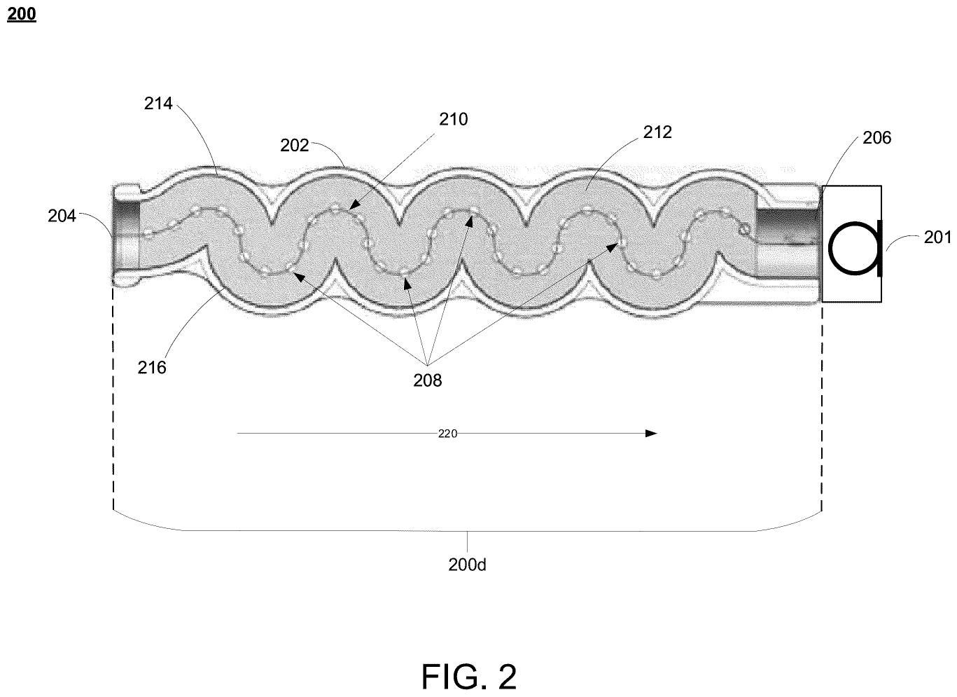

FIG. 2 illustrates tube 200 coupled to microphone capsule 201 and also illustrates additional features of tube 200. Tube 200 may be coupled to or appended to microphone capsule 201. Microphone capsule 201 may be integral to tube 200. Microphone capsule 201 may be any type of capsule, such as a condenser (such as a large- or small-diaphragm capsule or an electret condenser), dynamic (such as a moving coil or ribbon microphone capsule), and/or micro-electromechanical systems (MEMS), among others. Microphone capsule 201 may be constructed according to one or more geometries (such as round, oval, elliptical, rectangular, etc.).

Tube 200 may include an outer frame 202. Outer frame 202 may be constructed according to a number of shapes, or three-dimensional geometries, including cylindrical, square, rectangular, triangular, etc. As discussed above, frame 202 may include a front opening 204 and a rear opening 206. Frame 202 may include channel 212. Channel 212 may be formed by a first interior wall, or sidewall, 214 and a second interior wall, or sidewall, 216. Front opening 204 and rear opening 206 may form the ends of channel 212. Front opening 204 may permit on-axis sound waves to enter channel 212. The on-axis sound waves may travel through channel 212 to opening 206 and microphone capsule 201 (i.e., in the direction of arrow 220). Outer frame 202 may include microphone capsule 201.

Tube 200 may include a plurality of sound entrance holes 208 (hereinafter referred to as “holes 208”) disposed along outer frame 202 and integral to outer frame 202. Holes 208 may provide channels through which sound waves outside frame 202 may propagate into channel 212. That is, holes 208 may permit off-axis sound waves to enter channel 212 at various lengths relative to microphone capsule 201. Sound waves that enter channel 212 at different lengths relative to microphone capsule 201 may arrive at microphone capsule 201 out of phase with one another. Consequently, due to destructive interference, those unwanted off-axis sounds may be attenuated by the time they reach microphone capsule 201.

Holes 208 may be disposed along frame 202 according to a number of arrangements. For example, holes 208 may be arranged in a linear fashion (i.e., in a straight line) along the length of frame 202 from opening 204 to opening 206. Holes 208 may be arranged in a non-linear (i.e., not in a straight line) fashion along the length of frame 202. Holes 208 may be arranged according to the geometry of internal acoustic path 210. Holes 208 may be evenly spaced, although they may also be unevenly spaced. Tube 200 may include any number of holes 208 along frame 202. Holes 208 may be disposed on one or more sides of frame 202.

Frame 202 may share a similar geometry as channel 212. That is, if channel 212 has a sinusoidal geometry, frame 202 may also have a sinusoidal geometry. However, the geometries, or shapes, of frame 202 and channel 212 may be different from one another. In other words, if channel 212 has a sinusoidal geometry, frame 202 may have a rectangular, square, etc. geometry.

Channel 212 may form or define an internal acoustic path 210 through which acoustic waves may travel through channel 212 in the general direction of arrow 220 toward microphone capsule 201. In an example, channel 212 may be arranged with a geometry approximating a sinusoidal waveform with a given wavelength. Consequently, the path that sound waves must take through channel 212 (i.e., along internal acoustic path 210) may be dictated by the geometry of channel 212. In other words, channel 212 may prevent sound waves that enter holes 208 from traveling in a linear path from a respective hole 208 through channel 212 to microphone capsule 201, thus causing the sound waves to travel in a sinusoidal-like path through channel 212 toward microphone capsule 201.

As discussed above, internal acoustic path 210 may differ in length than an exterior dimension 200d of tube 200, in this example the linear length of tube 200. In an example, the length of internal acoustic path 210, or the distance sound waves must travel from any hole 208 through channel 212 to microphone capsule 201, may be greater than the corresponding length of tube 200 measured from said hole 208 to microphone capsule 201. Based on the length of acoustic path 210 being greater than the corresponding exterior dimension 200d of tube 200, tube 200 may possess similar time and/or phase delay characteristics as a tube with a greater exterior dimension than dimension 200d. As a result, tube 200 may have an extended low-frequency attenuation capability than an interference tube having the same linear footprint but lacking the non-linear internal acoustic path of tube 200d. Tube 200 may effectively reduce off-axis sound waves having a given frequency or occupying one or more frequency ranges by providing a space sufficient for the sound waves to deconstructively interfere with one another in channel 212 before reaching microphone capsule 201. A person of ordinary skill in the art would understand that the omission of some or all of these features from tube 200 does not depart from the scope of this disclosure.

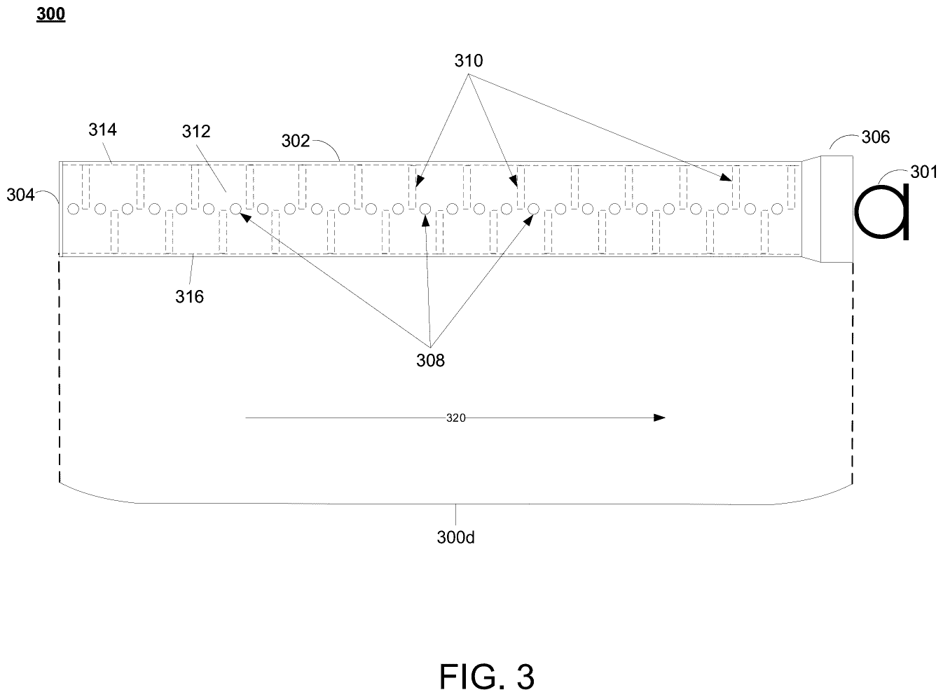

FIG. 3 illustrates a side-view of an example interference tube 300 (hereinafter referred to as “tube 300”) that may be used to implement one or more illustrative aspects described herein. Tube 300 may be coupled to or appended to microphone capsule 301. As with tube 200, microphone capsule 301 may be any type of capsule, such as condenser (e.g., including large- and small-diaphragm and electret condenser), dynamic (e.g., including moving coil and ribbon microphones), and/or micro-electromechanical systems (MEMS), among others. Microphone capsule 301 may be constructed according to one or more geometries (e.g., round, oval, elliptical, rectangular, etc.).

Tube 300 may include an outer frame 302. Outer frame 302 may be constructed according to a number of geometries, including cylindrical, square, rectangular, triangular, etc. Frame 302 may include a front opening 304 and a rear opening 306. Frame 302 may include channel 312. Channel 312 may be formed by sidewalls 314 and 316. Front opening 304 and rear opening 306 may form the ends of channel 312 and may permit on-axis sounds to travel from opening 304, through channel 312, to opening 306 and microphone capsule 301 (i.e., in the direction of arrow 320).

Tube 300 may include a plurality of sound entrance holes 308 (hereinafter referred to as “holes 308”) disposed along outer frame 302 and integral to outer frame 302. Holes 308 may provide channels through which sound waves outside frame 302 may propagate into channel 312.

That is, holes 308 may permit off-axis sound waves to enter channel 312. Holes 308 may be disposed along frame 302 according to a number of arrangements. For example, holes 308 may be arranged in a linear fashion (i.e., in a straight line) along the length of frame 302 from opening 304 to opening 306. Holes 308 may be arranged in a non-linear (i.e., not in a straight line) fashion along the length of frame 302. Holes 308 may be evenly spaced, although they may also be unevenly spaced. Tube 300 may include any number of holes 308 along frame 302. Holes 308 may be disposed on one or more sides of frame 302.

Tube 300 may include a plurality of obstruction baffles 310 (hereinafter referred to as “baffles 310”). Tube 300 may include various numbers of baffles 310 (i.e., 1, 2, 3, 4, 5, 6, 10, etc.). Baffles 310 may be constructed from a number of materials, including materials that display sound-dampening qualities. Baffles 310 may be constructed from any number of resilient, non-porous materials, such as any number of polymers, metals, and the like. Baffles 310 may be coupled to a first interior wall, or sidewall, 314 and/or a second interior wall, or sidewall, 316. Baffles 310 may be integrally molded to sidewalls 314 and/or 316. Baffles 310 may extend lengthwise into channel 312. Baffles 310 may extend various distances from sidewalls 314 and/or 316 into channel 312. Some of baffles 310 may extend a first distance from sidewalls 314 and/or 316 into channel 312, while other baffles 310 may extend a second distance from sidewalls 314 and/or 316 into channel 312. The first distance may be greater than, equal to, or smaller than the second distance.

Baffles 310 may form or define an internal acoustic path (not shown) through which acoustic waves may travel through channel 312 in the general direction of arrow 320 toward microphone capsule 301. In other words, baffles 310 may prevent sound waves that enter holes 308 from traveling in a linear path from their entrance point into channel 312 to microphone capsule 301, thus causing the sound waves to travel in a serpentine-like path around baffles 310. Accordingly, the internal acoustic path defined by baffles 310 may differ in length than an exterior dimension 300d of tube 300, in this example the length of tube 300. In an example, the length of the internal acoustic path, or the distance sound waves must travel from any hole 308 through channel 312 to microphone capsule 301, may be greater than the corresponding length of tube 300 measured from said hole 308 to microphone capsule 301. Based on the length of the acoustic path being greater than the corresponding length of tube 300, tube 300 may possess similar time and/or phase delay characteristics as a tube with a greater exterior dimension 300d. As a result, tube 300 may have an extended low-frequency attenuation capability than an interference tube having the same linear footprint but lacking the non-linear internal acoustic path of tube 300d.

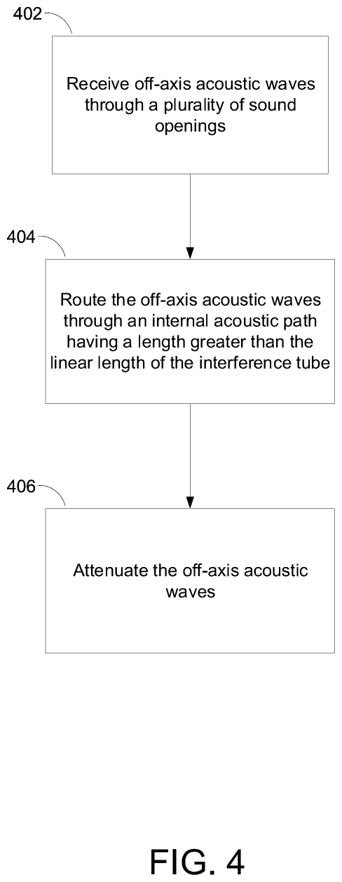

FIG. 4 illustrates an example flow chart of a method 300 that may be performed. Some or all of the steps may be performed by interference tube 200. While the method shows particular steps in a particular order, the method may be further subdivided into additional sub-steps, steps may be combined, the steps may be performed in other orders, and some steps may be omitted without necessarily deviating from the concepts described herein.

In operation, interference tubes 200, 300, or a structural equivalent (such as any cylindrical, rectangular, triangular, square, etc.) may receive one or more acoustic waves through one or more sound openings 208, 308, respectively. For purposes of simplicity, features of tube 200 will be referenced; however, it should be understood that the same applies to similar or equivalent features of tube 300 (i.e., internal acoustic path 208 of tube 200 corresponds to channel 312 of tube 300, and so on). In an example, tube 200 may receive a first acoustic wave may through a first opening 208, and a second acoustic wave (of the same or similar frequency) via a second opening 208 (step 402). The second opening may be closer to microphone capsule 201 or further from microphone capsule 201 than the first opening. The interference tube may route the first and second acoustic waves through internal acoustic path 210 (step 404). As has been discussed, the length of internal acoustic path 210 may be greater than dimension 200d of tube 200. As the first and second acoustic wave propagate toward microphone capsule 201, the waves may experience destructive interference according to the disclosure herein. Accordingly, tube 200 may significantly attenuate or cancel the first and second acoustic waves by the time the first and second acoustic waves reach a terminal end of tube 200 (such as, for example, rear opening 206 of tube 200) before reaching microphone capsule 201 (step 406). Microphone capsule 201 may be affixed to the terminal end of tube 200. Tube 200 may provide to microphone capsule 201 on-axis acoustic waves but might not provide the off-axis first and second acoustic waves due to their significant attenuation or interference with one another.

A method may be provided for attenuating sound received by a microphone. The method may comprise one or more operations. The method may comprise receiving, by an interference tube, a first off-axis acoustic wave through a first sound opening and receiving a second off-axis acoustic wave through a second sound opening. The method may comprise routing the first off-axis acoustic wave and the second off-axis acoustic wave through an internal acoustic path of the interference tube, wherein the internal acoustic path is longer than an external dimension of the interference tube. The method may comprise attenuating the first off-axis acoustic wave and the second off-axis acoustic wave. The first acoustic wave may travel a first distance through the internal acoustic path and the second acoustic wave may travel a second distance through the internal acoustic path, wherein the first distance may be greater than the second distance. The internal acoustic path may be formed with a geometry that approximates a sinusoidal waveform. The internal acoustic path may be formed with a helical geometry. The method may further comprise affixing a terminal end of the interference tube to a microphone. An interference tube may be provided that is configured to perform the above-described method. A microphone may be configured with the above-described interference tube. A system may comprise a microphone that may be configured with the above-described interference tube.

An interference tube for a microphone may comprise one or more components. The interference tube may comprise an internal acoustic path longer than an external dimension of the interference tube. The interference tube may comprise a plurality of sound entrance holes configured to receive a first acoustic wave and a second acoustic wave. The internal acoustic path may be configured to attenuate the first acoustic wave and the second acoustic wave. The internal acoustic path may be non-linear. The internal acoustic path may be disposed in one or more planes about an axis defined by a front opening of the interference tube and a terminal end of the interference tube. The internal acoustic path may be configured as a geometric waveform. The internal acoustic path may be configured with a helical geometry. The interference tube may further comprise a microphone capsule. The interference tube may further comprise a plurality of obstruction baffles disposed along a first interior wall and a second interior wall of the interference tube. The plurality of sound entrance holes may be arranged on an exterior frame of the interference tube according to the shape of the internal acoustic path.

An interference tube for a microphone may comprise a plurality of obstruction baffles disposed along a first interior wall and a second interior wall of the interference tube. An interference tube for a microphone may comprise an internal acoustic path defined by the plurality of obstruction baffles. The internal acoustic path may be longer than an external dimension of the interference tube. An interference tube may comprise a plurality of sound entrance holes. The internal acoustic path may be configured to attenuate at least a first acoustic wave and a second acoustic wave that enter the internal acoustic path through one or more of the plurality of sound entrance holes. The plurality of sound entrance holes may be arranged on an exterior housing of the interference tube according to the shape of the internal acoustic path. The internal acoustic path may be configured as a geometric waveform. The internal acoustic path may be configured to occupy one or more planes about an axis defined by a front opening of the interference tube and a terminal end of the interference tube. The internal acoustic path may be configured with a helical geometry.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrated rather than restrictive sense. Accordingly, it is not intended that the invention be limited except as may be necessary in view of the appended claims.

1. An interference tube for a microphone, wherein the interference tube comprises:
an internal acoustic path longer than an external dimension of the interference tube; and
a plurality of sound entrance holes configured to receive a first acoustic wave and a second acoustic wave, wherein the internal acoustic path is configured to attenuate the first acoustic wave and the second acoustic wave.

2. The interference tube of claim 1, wherein the internal acoustic path is non-linear.

3. The interference tube of claim 1, wherein the internal acoustic path is disposed in one or more planes about an axis defined by a front opening of the interference tube and a terminal end of the interference tube.

4. The interference tube of claim 1, wherein the internal acoustic path is configured as a geometric waveform.

5. The interference tube of claim 1, wherein the internal acoustic path is configured with a helical geometry.

6. The interference tube of claim 1, further comprising a microphone capsule.

7. The interference tube of claim 1, further comprising a plurality of obstruction baffles disposed along: a first interior wall of the interference tube, and a second interior wall of the interference tube.

8. The interference tube of claim 1, wherein the plurality of sound entrance holes are arranged on an exterior frame of the interference tube according to a shape of the internal acoustic path.

9. A method for attenuating sound received by a microphone, wherein the method comprises:
receiving, by an interference tube, a first off-axis acoustic wave through a first sound opening and a second off-axis acoustic wave through a second sound opening;
routing the first off-axis acoustic wave and the second off-axis acoustic wave through an internal acoustic path of the interference tube, wherein the internal acoustic path is longer than an external dimension of the interference tube; and
attenuating the first off-axis acoustic wave and the second off-axis acoustic wave.

10. The method of claim 9, wherein the routing comprises the first acoustic wave traveling a first distance through the internal acoustic path and the second acoustic wave traveling a second distance through the internal acoustic path, wherein the first distance is greater than the second distance.

11. The method of claim 9, wherein the routing the first off-axis acoustic wave and the second off-axis acoustic wave through the internal acoustic path follows a geometry that approximates a sinusoidal waveform.

12. The method of claim 9, wherein the routing the first off-axis acoustic wave and the second off-axis acoustic wave through the internal acoustic path follows a helical geometry.

13. The method of claim 9, further comprising affixing a terminal end of the interference tube to a microphone.

14. An interference tube for a microphone comprising:
a plurality of obstruction baffles disposed along a first interior wall of the interference tube and along a second interior wall of the interference tube; and
an internal acoustic path defined by the plurality of obstruction baffles, wherein the internal acoustic path is longer than an external dimension of the interference tube.

15. The interference tube of claim 14, further comprising a plurality of sound entrance holes.

16. The interference tube of claim 15, wherein the internal acoustic path is configured to attenuate at least a first acoustic wave and a second acoustic wave that enter the internal acoustic path through one or more of the plurality of sound entrance holes.

17. The interference tube of claim 15, wherein the plurality of sound entrance holes is arranged on an exterior housing of the interference tube according to a shape of the internal acoustic path.

18. The interference tube of claim 14, wherein the internal acoustic path is configured as a geometric waveform.

19. The interference tube of claim 14, wherein the internal acoustic path is configured to occupy one or more planes about an axis defined by: a front opening of the interference tube, and a terminal end of the interference tube.

20. The interference tube of claim 14, wherein the internal acoustic path is configured with a helical geometry.
